(19) United States
(12) Patent Application Publication
(10) Pub. No.: US 2022/0232861 A1
(43) Pub. Date: Jul. 28, 2022

(54) ZINC COMPOUNDS IN FOOD IMMERSION APPLICATIONS

(71) Applicant: SAFE FOODS CORPORATION, North Little Rock, AR (US)

(72) Inventors: Lindsey PERRY, Hensley, AR (US); Todd COLEMAN, Batesville, AR (US); Kate PARSONS, Little Rock, AR (US)

(21) Appl. No.: 17/597,161

(22) PCT Filed: Jul. 24, 2020
(86) PCT No.: PCT/US2020/043410

§ 371 Date: Dec. 28, 2021

Related U.S. Application Data
(60) Provisional application No. 62/879,258, filed on Jul. 26, 2019.

(51) Int. Cl. A23L 3/358; A23L 3/3517

(52) U.S. Cl. CPC A23L 3/358; A23L 3/3517

(57) ABSTRACT

A method of treating a food product includes immersing the food product in a treatment solution, the treatment solution including a zinc compound. A treatment solution for immersion applications of food products includes a zinc compound. A system for treating a food product includes: a container configured to receive the food product; and a treatment solution contained within the container. The container and treatment solution are capable of immersing the food product and the treatment solution includes a zinc compound.

### I. CROSS-REFERENCE TO RELATED APPLICATIONS

The present application claims benefit of U.S. Provisional Patent Application No. 62/879,258 filed Jul. 26, 2019, titled “USE OF ZINC SALTS IN PROTEIN IMMERSION APPLICATIONS,” which is incorporated herein by reference in its entirety.

### II. TECHNICAL FIELD

The present description relates to food immersion applications using zinc compounds, namely, zinc salts.

### III. BACKGROUND

Protein processing plants employ several immersion application points for the purposes of temperature control and microbial reduction of carcasses and parts. While the immersion application points can perform their functions very well, the application points can also be a source of high microbial concentration, resulting in cross-contamination. These immersion application points generally use oxidizing antimicrobials which function by oxidizing the cell membrane of microbes. However, oxidizing antimicrobials can be reduced, both chemically and in concentration, by organic materials such as blood, ingesta and fats that are natural components of the immersion application points, thereby reducing the efficacy of the antimicrobials. Therefore, a need exists at immersion application points for a non-oxidizing antimicrobial that is not affected by organic materials and are natural components of the process.

### IV. DETAILED DESCRIPTION

While the present disclosure is described herein with reference to illustrative embodiments for particular applications, it should be understood that the disclosure is not limited to such embodiments. Other embodiments are possible, and modifications can be made to the embodiments within the spirit and scope of the teachings herein and additional fields in which the embodiments would be of significant utility are also included.

Zinc is a metal having natural antimicrobial properties. In embodiments of the present disclosure, zinc compounds are incorporated into treatment solutions at immersion application points to reduce microbial concentration in the immersion application points during processing of workpieces.

The workpieces that may be treated with the treatment solutions described herein are not particularly limited. For instance, the zinc compounds may be incorporated into treatment solutions at immersion application points for workpieces that are proteins such as poultry carcasses and parts and other protein sources such as beef and pork hides, carcasses, trim, and grind. In other embodiments, the workpieces are non-protein products such as fruits or vegetables.

In one or more embodiments, the zinc compounds may include, but are not limited to, any water-soluble zinc salt. Examples of water-soluble zinc salts usable in the present disclosure include: zinc chloride, zinc bromide, zinc sulfate, zinc acetate, zinc nitrate; zinc oxide nanoparticles, zinc salts of peroxyacids such as zinc performate or zinc peracetate, or combinations thereof. In one or more embodiments, the antimicrobial zinc compounds are considered generally regarded as safe (“GRAS”) by the appropriate regulatory bodies. In one or more embodiments, the zinc compounds comprise zinc sulfate. Zinc sulfate is an acidic salt that has been shown to inhibit growth of enteric pathogens with low concentrations of zinc sulfate.

In one or more embodiments, the minimum concentration of the zinc compounds, measured as mass of zinc per total volume of treatment solution, may be set to a minimum inhibitory concentration (MIC) based on a target microbe. For instance, the MIC for zinc sulfate on Salmonella species is about 0.25 ppm (ppm as used herein refers to mg of zinc per L of treatment solution). In one or more embodiments, the concentration of the zinc compounds is at least, 0.25 ppm, at least 1 ppm, at least 5 ppm, at least 10 ppm, at least 20 ppm, at least 30 ppm, at least 40 ppm, at least 50 ppm, at least 70 ppm, at least 100 ppm, at least 150 ppm, at least 200 ppm, at least 300 ppm, at least 400 ppm, at least 500 ppm, at least 600 ppm, at least 700 ppm, at least 800 ppm, at least 900 ppm, at least 1000 ppm, at least 1100 ppm, at least 1200 ppm, at least 1300 ppm, at least 1400 ppm, or at least 1500 ppm.

On the other hand, strict wastewater regulations may require low zinc concentrations. Therefore, treatment solutions may be limited to low concentrations of zinc. In one or more embodiments, the maximum concentration of the zinc compounds, measured as mass of zinc per total volume of treatment solution, is 5000 ppm, 4500 ppm, 4000, ppm, 3500 ppm, 3000 ppm, 2750 ppm, 2500 ppm, 2250 ppm, 2000 ppm, 1750 ppm, 1500 ppm, 1400 ppm, 1300 ppm, 1200 ppm, 1100 ppm, 1000 ppm, 900 ppm, 800 ppm, 700 ppm, 600 ppm, 500 ppm, 400 ppm, 300 ppm, 200 ppm, 100 ppm, 80 ppm, 70 ppm, 60 ppm, 50 ppm, 40 ppm, or 30 ppm. In one or more embodiments, the concentration of the zinc compounds may range between any logical combination of the foregoing upper and lower bounds, such as 0.25-5000 ppm, 50-70 ppm, or 200-1000 ppm.

For any workpiece, the concentration of the zinc compounds may be as described above. In an embodiment, for a poultry processing facility application in a submersion chiller, the chiller may utilize a water solution that includes up to 2000 ppm zinc, prepared using tap water and the selected zinc compound. A pre-chiller application may contain approximately 70-100 ppm zinc, a mid-chiller application may contain approximately 50-70 ppm zinc, and a final chiller application may contain approximately 30-50 ppm zinc, with the potential of being as high as approximately 700-1000 ppm zinc at any of the foregoing locations.

In another embodiment, for a dip application of poultry parts, the treatment solution may contain approximately 500-1000 ppm zinc. In another embodiment, for a spray application of poultry parts, the treatment solution may contain approximately 50-1000 ppm zinc, or up to 2000 ppm zinc.

In embodiments including a beef processing plant, for a sub-primal spray cabinet, the treatment solution may contain approximately 200-400 ppm zinc. In embodiments for a pork processing plant, for a carcass rinse (or spray application) the treatment solution may contain approximately 200-400 ppm zinc. In other embodiments for the processing of fruits and vegetables, the concentration of the treatment solution may be lower, containing approximately 20-100 ppm zinc, or go as high as 700 ppm zinc.

The treatment solution may contain additives such as solvents, carriers, oxidizing agents, viscosity builders, antioxidants, flavoring agents, preservatives, buffers, surfactants, solubility-enhancing agents, pH adjusters, or any combination thereof. Suitable solvents may include, for example, water, alcohols, organic solvents, or a combination thereof. Oxidizing agents may include, for instance, hydrogen peroxide, acylperoxy acids, ozone, or chlorine-based oxidizers.

According to one or more embodiments, the treatment solution has a pH of no more than 5, 4, 3, 2.5, 2, 1.7, 1.5, 1.2, or 1.0. In some embodiments, the treatment solution includes an acid. In one or more embodiments, the acid is sulfuric acid, acetic acid, phosphoric acid, citric acid, hydrochloric acid, lactic acid, or malic acid. In one or more embodiments, a weight ratio of the acid to the zinc compounds is 1:30, 1:20, 1:15, 1:10, 1:5, 1:2, 1:1, 2:1, 5:1, 10:1, 15:1, 20:1, or 30:1. In some embodiments, the weight ratio of the acid to the zinc compounds may range between any logical combination of the foregoing ratios.

Methods of applying the treatment solution to workpieces may include, but are not limited to, spraying, misting, fogging, immersing, pouring, dripping, and combinations thereof. Some methods of applying the treatment solutions relate to sanitizing food products or equipment during harvest and processing of the food product. Throughout the harvest process, there are many opportunities for antimicrobial interventions, and determining what works most effectively at each step may differ from processor to processor. As such, the timing of applying the treatment solution to the workpieces is not particularly limited. In some embodiments, the treatment solution may be applied to a workpiece prior to an evisceration process so as to adhere to the workpiece throughout the evisceration process, as well as when coming into contact with equipment, viscera, and humans.

In embodiments wherein the target article is poultry, the treatment solution may be applied in the processing facility in several different locations including, but not limited to, an immersion application such as a post-pick dip, drag dip, COPE® pre-chiller, pre-chiller, chiller, COPE® post-chiller, or parts dip.

In embodiments wherein the target article is beef or pork, the treatment solution may be applied in the processing facility in several different locations including, but not limited to, the following: hide on carcass application; equipment used during the harvest process; knife dip station; beef carcass application; sub-primal application; lean trimming application; and ground beef applications.

In embodiments wherein the target article is fruit or vegetables, the treatment solution may be applied in the processing facility in several different locations including, but not limited to, the following: all loading/unloading; all treatment pre- and post-flume; and prior and post to all cut up and smash treatment.

In some embodiments, the present disclosure relates to a method for processing a food product (workpiece), the method comprising sanitizing a food product with regard to at least one microorganism. In some embodiments, sanitizing a food product with regard to at least one microorganism may comprise contacting the food product with the treatment solution described herein. In various embodiments, the microorganisms may comprise Gram-positive bacteria, Gram-negative bacteria, fungi, protozoa or a combination thereof. The Gram-negative bacteria may comprise Salmonella, Campylobacter, Arcobacter, Aeromonas, non-toxin-producing Escherichia, pathogenic toxin-producing Escherichia or a combination thereof. The Gram-positive bacteria may comprise Staphylococcus, Bacillus, Listeria, or a combination thereof. The fungi may comprise Aspergillus flavus, Penicillium chrysogenum, or a combination thereof. The protozoa may comprise Entamoeba histolytica.

In some embodiments, the present disclosure relates to a method of sanitizing a workpiece with regard to at least one microorganism, the method comprising contacting the workpiece with the treatment solution described herein. The microorganism may, for example, be as described above. The workpiece may, for example, include food packaging, items and surfaces related to food or food processing, or items and surfaces unrelated to food or food processing.

### EXAMPLES

### Example 1

Drums (poultry) were purchased from a local retailer, frozen, and thawed for testing. The parts were stored at refrigeration temperatures until time of testing. As a control, five drums (Sample IDs 1-5) were individually, aseptically rinsed (as referenced herein, rinsing is per FSIS Directive 10,250.1; in Example 1, 40 ml of rinsate was used). These drums represent what was microbiologically present on the drums before treatment.

Next, a solution of 1% zinc sulfate/sulfuric acid (concentrations described herein are based on zinc content) was slowly added and manually agitated into 1 gallon of water. A total of 233 mL of the 1% solution was added to yield a solution with a final pH of 2.96. Five drums (Sample IDs 6-10) were fully submerged in the zinc sulfate/sulfuric acid solution, manually agitated for 10 seconds, then removed and allowed to drip for 60 seconds. The drums were individually, aseptically rinsed.

Next, 1 gallon of water and 1,893 mL of a 50 ppm zinc sulfate/sulfuric acid solution were combined in a bucket to yield a 25 ppm zinc sulfate/sulfuric acid solution. Five drums (Sample IDs 11-15) were fully submerged in the zinc sulfate/sulfuric acid solution, manually agitated for 10 seconds, then removed and allowed to drip for 60 seconds. The drums were individually, aseptically rinsed.

Finally, 2 gallons of water and 757 mL of a 500 ppm zinc sulfate/sulfuric acid solution were combined in a bucket to yield a 50 ppm zinc sulfate/sulfuric acid solution. Five drums (Sample ID's 16-20) were fully submerged in the zinc sulfate/sulfuric acid solution, manually agitated for 10 seconds, then removed and allowed to drip for 60 seconds. The drums were individually, aseptically rinsed.

All rinsate samples collected were placed in a refrigerator overnight. The samples were analyzed for 3M Aerobic Plate Count (APC) Petrifilm™ (AOAC Official Method 990.12), and Enterobacteriaceae (EB) Petrifilm™ (AOAC Official Method 2003.01). The samples were recorded as counts, which were then converted to log₁₀ CFU/mL for statistical analysis of the means. The results are summarized in Table 1 below.

TABLE 1

| | Aerobic plate count | Enterobacteriaceae |
|---|---|---|
| Treatment Solution | (log₁₀ CFU/ml) | (log₁₀ CFU/ml) |
| Sample IDs 1-5 (control) | 8.5 | 7.1 |
| Sample IDs 6-10 (1% zinc | 8.0 | 7.3 |
| sulfate/sulfuric acid) | | |
| Reduction from | 0.5 | + 0.2 |
| control | | |
| P-Value* | 0.0001 | 0.0473 |
| Sample IDs 11-15 (25 ppm | 7.8 | 7.1 |
| zinc sulfate/sulfuric acid) | | |
| Reduction from | 0.7 | 0.0 |
| control | | |
| P-Value* | 0.0001 | 0.8358 |
| Sample IDs 16-20 (50 ppm | 7.7 | 6.8 |
| zinc sulfate/sulfuric acid) | | |
| Reduction from | 0.8 | 0.3 |
| control | | |
| P-Value* | 0.0001 | 0.2413 |

*Using a 95% confidence interval where a = 0.05, a P-Value < a indicates statistical significance.

Table 1 above shows statistically significant microbial reduction in APC for all zinc sulfate/sulfuric acid treatment groups when used on poultry parts in a dip application when compared to the control group.

EB analysis showed a statistically significant microbial growth with the 1% zinc sulfate/sulfuric acid. The 25 ppm zinc sulfate/sulfuric acid treatment group showed no microbial reduction or growth from a control group while 50 ppm zinc sulfate/sulfuric acid treatment group shows slight microbial reduction, but not a statistically significant reduction. This Example suggests that a higher concentration of zinc sulfate leads to higher microbial reduction on poultry parts in a dip application. However, wastewater regulations are the limiting factor in determining maximum concentrations of zinc allowed in treatments.

### Example 2

Drums (poultry) were purchased from a local retailer, frozen, and thawed for testing. The parts were stored at refrigeration temperatures for 72 hours, then allowed to sit at room temperature for 24 hours prior to testing. As a control, five drums (Sample IDs 1-5) were individually, aseptically rinsed (100 ml of rinsate).

Next, approximately 82 mL of a 3,000 ppm zinc sulfate/sulfuric acid solution was added and manually agitated in 1 gallon of tap water in a 3-gallon bucket to yield a 50 ppm zinc sulfate/sulfuric acid solution. The pH was recorded as 1.2. Five drums (Sample IDs 6-10) were fully submerged in the zinc sulfate/sulfuric acid solution, manually agitated for 10 seconds, then removed and allowed to drip for 60 seconds. The drums were individually, aseptically rinsed.

Next, 1 gallon of water and 630 mL of a 3,000 ppm zinc sulfate/sulfuric acid solution were added to a bucket to yield a 500 ppm zinc sulfate/sulfuric acid solution. Five drums (Sample IDs 11-15) were fully submerged in the zinc sulfate/sulfuric acid solution, manually agitated for 10 seconds, then removed and allowed to drip for 60 seconds. The drums were individually, aseptically rinsed.

Next, 1 gallon of water and 1,262 mL of a 3,000 ppm zinc sulfate/sulfuric acid solution were added to a bucket to yield a 1,000 ppm zinc sulfate/sulfuric acid solution. Five drums (Sample IDs 16-20) were fully submerged in the zinc sulfate/sulfuric acid solution, manually agitated for 10 seconds, then removed and allowed to drip for 60 seconds. The drums were individually, aseptically rinsed.

Lastly, 1 gallon of water and 1,893 mL of a 3,000 ppm zinc sulfate/sulfuric acid solution were added to a bucket to yield a 1,500 ppm zinc sulfate/sulfuric acid solution. Five drums (Sample IDs 21-25) were fully submerged in the zinc sulfate/sulfuric acid solution, manually agitated for 10 seconds, then removed and allowed to drip for 60 seconds. The drums were individually, aseptically rinsed.

All rinsate samples collected were placed in a refrigerator overnight. The samples were analyzed for 3M Aerobic Plate Count (APC) Petrifilm™ (AOAC Official Method 990.12) and Enterobacteriaceae (EB) Petrifilm™ (AOAC Official Method 2003.01). The samples were recorded as counts, which were then converted to log₁₀ CFU/mL for statistical analysis of the means. The results are summarized in Table 2 below.

TABLE 2

| | Aerobic plate count | Enterobacteriaceae |
|---|---|---|
| Treatment Solution | (log₁₀ CFU/ml) | (log₁₀ CFU/ml) |
| Sample IDs 1-5 (control) | 5.1 | 2.2 |
| Sample IDs 6-10 (50 ppm zinc | 4.3 | 1.7 |
| sulfate/sulfuric acid) | | |
| Reduction from control | 0.8 | 0.5 |
| P-Value* | 0.0883 | 0.1256 |
| Sample IDs 11-15 (500 ppm zinc | 4.4 | 1.2 |
| sulfate/sulfuric acid) | | |
| Reduction from control | 0.7 | 1.0 |
| P-Value* | 0.0096 | 0.0099 |
| Sample IDs 16-20 (1000 ppm | 4.1 | 1.4 |
| zinc sulfate/sulfuric acid) | | |
| Reduction from control | 1.0 | 0.8 |
| P-Value* | 0.0111 | 0.2056 |
| Sample IDS 21-25 (1500 ppm | 3.6 | 1.0 |
| zinc sulfate/sulfuric acid) | | |
| Reduction from control | 1.5 | 1.2 |
| P-Value* | 0.0001 | 0.0044 |

*Using a 95% confidence interval where a = 0.05, a P-Value < a indicates statistical significance.

Table 2 above shows statistically significant microbial reduction in APC for all zinc sulfate/sulfuric acid treatment groups—except for the 50 ppm zinc sulfate/sulfuric acid solution—when used on poultry parts in a dip application when compared to the control group.

EB analysis showed a statistically significant microbial reduction with the 500 ppm and 1500 ppm zinc sulfate/sulfuric acid solutions. As with Example 1, this Example suggests that a higher concentration of zinc sulfate leads to higher microbial reduction on poultry parts in a dip application. However, wastewater regulations are the limiting factor in determining maximum concentrations of zinc allowed in treatments.

### Example 3

Drums (poultry) were purchased from a local retailer, frozen, and thawed for testing. The parts were allowed to sit at room temperature for 24 hours prior to testing. As a control, five drums (Sample IDs 1-5) were individually, aseptically rinsed (100 ml of rinsate).

Next, approximately 630 mL of 3,000 ppm zinc sulfate was added and manually agitated in 1 gallon of tap water in a 3-gallon bucket to yield a 500 ppm zinc sulfate solution. Five drums (Sample IDs 6-10) were fully submerged in the zinc sulfate solution, manually agitated for 10 seconds, then removed and allowed to drip for 60 seconds. The drums were individually, aseptically rinsed.

Next, 1 gallon of water and 4 ml of sulfuric acid were added to a bucket to yield a solution having a pH of 1.2. Five drums (Sample IDs 11-15) were fully submerged in the sulfuric acid solution, manually agitated for 10 seconds, then removed and allowed to drip for 60 seconds. The drums were individually, aseptically rinsed.

Lastly, 1 gallon of water and 630 mL of 3,000 ppm zinc sulfate/sulfuric acid solution were added to a bucket to yield a 500 ppm zinc sulfate/sulfuric acid solution having a pH of 1.2. Five drums (Sample IDs 16-20) were fully submerged in the zinc sulfate/sulfuric acid solution, manually agitated for 10 seconds, then removed and allowed to drip for 60 seconds. The drums were individually, aseptically rinsed.

All rinsate samples collected were placed in a refrigerator overnight. The samples were analyzed for 3M Aerobic Plate Count (APC) Petrifilm™ (AOAC Official Method 990.12), E. coli/Coliform (EC/CO) Petrifilm™ (AOAC Official Method 998.08), and Enterobacteriaceae (EB) Petrifilm™ (AOAC Official Method 2003.01). The samples were recorded as counts, which were then converted to log₁₀ CFU/mL for statistical analysis of the means. The results are summarized in Table 3 below.

TABLE 3

| | Aerobic plate count | Enterobacteriaceae |
|---|---|---|
| Treatment Solution | (log₁₀ CFU/ml) | (log₁₀ CFU/ml) |
| Sample IDs 1-5 (control) | 5.2 | 2.8 |
| Sample IDs 6-10 (500 ppm | 4.5 | 1.7 |
| zinc sulfate) | | |
| Reduction from | 0.7 | 1.1 |
| control | | |
| P-Value* | 0.2109 | 0.1120 |
| Sample IDs 11-15 (1.2 pH | 4.6 | 1.7 |
| sulfuric acid) | | |
| Reduction from | 0.6 | 1.1 |
| control | | |
| P-Value* | 0.2652 | 0.1493 |
| Sample IDs 16-20 (500 ppm | 4.4 | 1.0 |
| zinc sulfate/sulfuric acid) | | |
| Reduction from | 0.8 | 1.8 |
| control | | |
| P-Value* | 0.2451 | 0.0392 |

*Using a 95% confidence interval where a = 0.05, a P-Value < a indicates statistical significance.

Table 3 above shows statistically significant microbial reduction in EB analysis for the 500 ppm zinc sulfate/sulfuric acid treatment groups. This Example suggests that zinc sulfate does individually exhibit some antimicrobial properties. These properties are shown to be improved when the zinc sulfate is combined with sulfuric acid.

### Example 4

Drums (poultry) were purchased from a local retailer, frozen, and thawed for testing. The parts were allowed to sit at room temperature for 24 hours prior to testing. As a control, five drums (Sample IDs 1-5) were individually, aseptically rinsed (100 ml of rinsate).

Next, approximately 630 mL of 3,000 ppm zinc sulfate was added and manually agitated in 1 gallon of tap water in a 3-gallon bucket to yield a 500 ppm zinc sulfate solution. Five drums (Sample IDs 6-10) were fully submerged in the zinc sulfate solution, manually agitated for 10 seconds, then removed and allowed to drip for 60 seconds. The drums were individually, aseptically rinsed.

Next, sulfuric acid was added and manually agitated in 1 gallon of tap water in a bucket to yield a solution having a pH of 1.2. Five drums (Sample IDs 11-15) were fully submerged in the sulfuric acid solution, manually agitated for 10 seconds, then removed and allowed to drip for 60 seconds. The drums were individually, aseptically rinsed.

Lastly, 1 gallon of water and 630 mL of 3,000 ppm zinc sulfate/sulfuric acid solution were added to a bucket to yield a 500 ppm zinc sulfate/sulfuric acid solution having a pH of 1.2. Two sets of five drums (Sample IDs 16-20 and 21-25) were fully submerged in the zinc sulfate/sulfuric acid solution, manually agitated for 10 seconds, then removed and allowed to drip for 60 seconds. The drums were individually, aseptically rinsed.

All rinsate samples collected were placed in a refrigerator overnight. The samples were analyzed for 3M Aerobic Plate Count (APC) Petrifilm™ (AOAC Official Method 990.12), and Enterobacteriaceae (EB) Petrifilm™ (AOAC Official Method 2003.01). The samples were recorded as counts, which were then converted to log₁₀ CFU/mL for statistical analysis of the means. The results are summarized in Table 4 below.

TABLE 4

| | Aerobic plate count | Enterobacteriaceae |
|---|---|---|
| Treatment Solution | (log₁₀ CFU/ml) | (log₁₀ CFU/ml) |
| Sample IDs 1-5 (control) | 7.9 | 4.9 |
| Sample IDs 6-10 (500 ppm | 7.2 | 3.3 |
| zinc sulfate) | | |
| Reduction from | 0.7 | 1.9 |
| control | | |
| P-Value* | 0.0215 | 0.0009 |
| Sample IDs 11-15 (1.2 pH | 7.2 | 4.4 |
| sulfuric acid) | | |
| Reduction from | 0.7 | 0.5 |
| control | | |
| P-Value* | 0.0082 | 0.0476 |
| Sample IDs 16-20 (500 ppm | 6.6 | 3.2 |
| zinc sulfate/sulfuric acid) | | |
| Reduction from | 1.3 | 1.7 |
| control | | |
| P-Value* | 0.0009 | 0.0122 |
| Sample IDs 21-25 (500 ppm | 6.5 | 3.2 |
| zinc sulfate/sulfuric acid) | | |
| Reduction from | 1.4 | 1.7 |
| control | | |
| P-Value* | 0.0001 | 0.0008 |

*Using a 95% confidence interval where a = 0.05, a P-Value < a indicates statistical significance.

Table 4 above shows statistically significant microbial reduction in APC and EB analysis for the 500 ppm zinc sulfate only samples (6-10). Additionally, sulfuric acid treatment with a solution having a pH of 1.2 or less provided statistically significant reductions in APC and EB analysis. However, the combination of sulfuric acid and zinc sulfate in samples 16-25 showed greater reduction in APC analysis than either of the individual treatments.

Zinc sulfate has natural antimicrobial properties that are shown herein to effectively reduce microbial loads on poultry parts. When combined with sulfuric acid, the pH adjustment adds an additional mode of defense against bacteria. As shown herein, a zinc sulfate/sulfuric acid solution provides a synergistic antimicrobial that increase antimicrobial efficacy when compared to solutions of the individual components.

The above specific example embodiments are not intended to limit the scope of the claims. The example embodiments may be modified by including, excluding, or combining one or more features or functions described in the disclosure. The description of the present disclosure has been presented for purposes of illustration and description but is not intended to be exhaustive or limited to the embodiments in the form disclosed. Many modifications and variations will be apparent to those of ordinary skill in the art without departing from the scope and spirit of the disclosure. The illustrative embodiments described herein are provided to explain the principles of the disclosure and the practical application thereof, and to enable others of ordinary skill in the art to understand that the disclosed embodiments may be modified as desired for a particular implementation or use. The scope of the claims is intended to broadly cover the disclosed embodiments and any such modification.

What is claimed is:

1. A method of treating a food product, comprising:
immersing the food product in a treatment solution;
wherein the treatment solution comprises a zinc compound.

2. The method of claim 1, wherein the food product comprises poultry and the treatment solution comprises 30-1000 ppm of zinc.

3. The method of claim 1, wherein the food product comprises beef or pork and the treatment solution comprises 200-400 ppm of zinc.

4. The method of claim 1, wherein the food product comprises a fruit or vegetable and the treatment solution comprises 20-100 ppm of zinc.

5. The method of claim 1, wherein the treatment solution further comprises an acid selected from sulfuric acid, acetic acid, phosphoric acid, citric acid, hydrochloric acid, lactic acid, and/or malic acid.

6. The method of claim 5, wherein the acid is sulfuric acid.

7. The method of claim 6, wherein a weight ratio of the sulfuric acid to zinc in the treatment solution is from 1:30 to 1:1.

8. The method of claim 5, wherein the treatment solution comprises 300-700 ppm of zinc.

9. The method of claim 8, wherein the pH of the treatment solution is less than 3.

10. The method of claim 1, wherein the zinc compound comprises zinc chloride, zinc bromide, zinc sulfate, zinc acetate, zinc nitrate, zinc oxide nanoparticles, zinc performate, zinc peracetate, or combinations thereof.

11. A treatment solution for immersion applications of food products, the treatment solution comprising:
a zinc compound in an amount such that the treatment solution comprises 20-3000 ppm of zinc.

12. The treatment solution of claim 11, further comprising an acid selected from sulfuric acid, acetic acid, phosphoric acid, citric acid, hydrochloric acid, lactic acid, and/or malic acid.

13. The treatment solution of claim 12, wherein the acid is sulfuric acid.

14. The treatment solution of claim 11, wherein a pH of the treatment solution is less than 3.

15. The treatment solution of claim 11, wherein the zinc compound comprises zinc chloride, zinc bromide, zinc sulfate, zinc acetate, zinc nitrate, zinc oxide nanoparticles, zinc performate, zinc peracetate, or combinations thereof.

16. A system for treating a food product, the system comprising:
a container configured to receive the food product; and
a treatment solution contained within the container;
wherein the container and treatment solution are capable of immersing the food product; and
wherein the treatment solution comprises a zinc compound.

17. The system of claim 16, wherein the treatment solution further comprises an acid selected from sulfuric acid, acetic acid, phosphoric acid, citric acid, hydrochloric acid, lactic acid, and/or malic acid.

18. The system of claim 17, wherein the acid is sulfuric acid.

19. The system of claim 18, wherein a weight ratio of the sulfuric acid to zinc in the treatment solution is from 1:30 to 1:1.

20. The system of claim 16, wherein the zinc compound comprises zinc chloride, zinc bromide, zinc sulfate, zinc acetate, zinc nitrate, zinc oxide nanoparticles, zinc performate, zinc peracetate, or combinations thereof.
